(19) United States
(12) Patent Application Publication
(10) Pub. No.: US 2005/0185658 A1
(43) Pub. Date: Aug. 25, 2005

(54) Gateway apparatus connected to a plurality of networks forming respective different network segments, and program and method for transferring IP packets

(75) Inventors: Toru Kamiwada, Kawasaki (JP); Toshihiro Sonoda, Kawasaki (JP); Takuya Sakamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/862,394

(22) Filed: Jun. 8, 2004

(30) Foreign Application Priority Data
Feb. 25, 2004 (JP) 2004-49137

(51) Int. Cl. H04L 12/66

(52) U.S. Cl. 370/401

(57) ABSTRACT

A gateway apparatus has a first IP address for the first network and a second IP address for the second network. The gateway apparatus includes: an information provision unit for receiving, from a second apparatus having a third IP address over the first network, a first IP packet representative of a search request for information resources; and a search unit for transmitting over the second network a second IP packet representative of a search request for information resources which packet contains the second IP address as a source address and for receiving a third IP packet which contains a first information resource identifier representative of an information resource available with a third apparatus on the second network. The first information resource identifier contains a fourth IP address for the third apparatus. The information provision unit rewrites the first information resource identifier to a second information resource identifier containing the first IP address for the first network, and then transmits a fourth IP packet containing the second information resource identifier and the third IP address as a destination address over the first network to the second apparatus.

### FIELD OF THE INVENTION

The present invention relates to a gateway apparatus for bidirectionally transferring messages between at least two networks.

### BACKGROUND OF THE INVENTION

A service providing device capable of providing audio/visual (A/V) information and other services may be connected to an external network and serve as a gateway apparatus. In this case, a mobile device on an external mobile network directly accesses the service providing device to use services provided by such an A/V device.

Such a service providing device may be connected to a separate gateway apparatus that is in turn connected to an external network via a residential network. In this case, for mobile devices on an external mobile network to use services provided by such an A/V device, port transferring and other information must be preset in the gateway apparatus, and the gateway apparatus must be preset so as to transfer or relay access from mobile devices to such A/V devices.

Okuyama in Japanese Patent Publication JP-2001-308934-A published on Nov. 2, 2001 discloses a communication control apparatus, in which, before a given processing request is issued from a client device and in response to an instruction from a server device, an address storage device stores a global address and a port number in the global address, converted from a server device local address and a port number in the local address, in association with the local address and the port number in the local address. A connection is automatically established with a server device, in which an undisclosed local address and a port number therein are set.

In accordance with one aspect of the present invention, a gateway apparatus connected to a plurality of networks which form respective different network segments. The plurality of networks include first and second networks. The gateway apparatus has a first IP address for the first network and a second IP address for the second network. The gateway apparatus includes: an information provision unit for receiving, from a second apparatus having a third IP address over the first network, a first IP packet representative of a search request for information resources which packet contains the third IP address as a source address; and a search unit for transmitting over the second network a second IP packet representative of a search request for information resources which packet contains the second IP address as a source address, in response to the first IP packet representative of the search request for information resources, and for receiving over the second network a third IP packet which contains a first information resource identifier representative of an information resource available with a third apparatus on the second network. The first information resource identifier contains a fourth IP address for the third apparatus. The gateway apparatus further includes a storage unit for storing the third and fourth IP addresses and the first information resource identifier in association with each other. The information provision unit reads the first information resource identifier from the storage unit, rewrites the read first information resource identifier to a second information resource identifier containing the first IP address for the first network, and then transmits a fourth IP packet containing the second information resource identifier and the third IP address as a destination address over the first network to the second apparatus. The fourth IP address within the first information resource identifier is rewritten to the first IP address. The gateway apparatus further includes a transfer unit. When a fifth IP packet containing the third IP address as a source address and the first IP address as a destination address is received by the gateway apparatus from the second apparatus over the first network, the transfer unit rewrites the fifth IP packet to a sixth IP packet for the second network containing the second IP address as a source address and the fourth IP address as a destination address, and then transfers the sixth IP packet over the second network to the third apparatus having a desired information resource. In the rewriting, the third IP address in the fifth IP packet is rewritten to the second IP address, and the first IP address in the fifth IP packet is rewritten to the fourth IP address.

In accordance with another aspect of the invention, a gateway apparatus connected to at least first and second networks which form respective different network segments. The gateway apparatus has a first IP address for the first network and a second IP address for the second network. The gateway apparatus includes a search unit for regularly transmitting over the second network an IP packet representative of a search request for information resources which packet contains the second IP address as a source address and for receiving over the second network a response IP packet which contains an information resource identifier representative of an available information resource of an available apparatus on the second network. The information resource identifier contains an IP address of the available apparatus. The gateway apparatus further includes: a storage unit for storing the IP address of the available apparatus and the information resource identifier in association with each other; and an information provision unit for receiving, from a second apparatus having a third IP address over the first network, a first IP packet representative of a search request for information resources which packet contains the third IP address as a source address. When the first IP packet is received by the gateway apparatus, the information provision unit stores in a list form the third IP address in association with the IP address of the available apparatus and the information resource identifier, reads from the storage unit a first information resource identifier representative of an available information resource of an available third apparatus on the second network, rewrites the read first information resource identifier to a second information resource identifier for the first network containing the first IP address, and the transmits over the first network to the second apparatus a fourth IP packet containing the second information resource identifier in a list form and the third IP address as a destination address. The first information resource identifier contains a fourth IP address of the third apparatus. The fourth IP address in the first information resource identifier is rewritten to the first IP address. The gateway apparatus further includes a transfer unit. When a fifth IP packet containing the third IP address as a source address and the first IP address as a destination address is received by the gateway apparatus from the second apparatus over the first network, the transfer unit rewrites the fifth IP packet to a sixth IP packet for the second network containing the second IP address as a source address and the fourth IP address as a destination address, and then transmits the sixth IP packet over the second network to the third apparatus having a desired information resource. In the rewriting, the third IP address in the fifth IP packet is rewritten to the second IP address and the first IP address in the fifth IP packet is rewritten to the fourth IP address.

The invention is also directed to a program for use in the information processing apparatus as described above.

The invention is also directed to a method in the information processing apparatus as described above.

According to the invention, between at least two networks forming respective different network segments, a device on one of the networks is allowed to use services provided by a device on another one of the networks, while preventing unauthorized access.

### BRIEF DESCRIPTION OF THE DRAWINGS

FIG. 1 shows a schematic system in accordance with an embodiment of the present invention that includes a gateway apparatus for UPnP audio and/or visual (A/V) content services as a network service providing device, and A/V devices, which are interconnected via an internal network, and external information processing terminals as network service using devices are connected to an external network to which the gateway apparatus is connected;

FIG. 2 shows a more detailed configuration of the gateway apparatus, the A/V devices and the external information processing terminals;

FIG. 3 shows a procedure for processing UPnP A/V content services provided by the A/V devices via the gateway apparatus to the external information processing terminal;

FIG. 4A illustrates network service transfer information stored in the storage unit;

FIG. 4B shows the relationship stored in the storage unit 128 between private URLs containing private IP addresses and port numbers for the internal network and global URLs containing global IP addresses and port numbers for the external network;

FIG. 5 shows a flowchart for device search, performed by the gateway apparatus in response to a request by the external terminal;

FIG. 6 shows a flowchart for transferring IP packet, performed by the gateway apparatus in response to receipt of an IP packet representative of a request for URL acquisition from the external terminal;

FIG. 7 shows a flowchart for transferring a response IP packet, performed by the gateway apparatus when it receives response IP packets from the A/V devices in response to a request by the external terminal;

FIGS. 8A and 8B show a modification of FIG. 5, which is another flowchart for device search, performed by the gateway apparatus in response to a request of the external terminal;

FIGS. 9A and 9B show a modification of FIGS. 8A and 8B, which is a further flowchart for device search, performed by the gateway apparatus; and

FIG. 10 shows a list of discovered network service information stored in the storage unit.

### DESCRIPTION OF THE PREFERRED EMBODIMENTS

There is difference between global and private IP addresses for respective external and residential networks, and security settings, such as packet filtering, are made on a gateway apparatus. Thus, for a mobile device to access a residential network and use services of a device on the residential network, address conversion, port transferring and other settings must be made on the gateway apparatus. However, if port transferring and other settings are made even when such services are not actually used, there is a risk that residential network devices are exposed to external unauthorized access. However, making such settings each time such services are used is troublesome for users.

The inventors have recognized that it would be advantageous if the gateway apparatus safely provides, in response to access from a device on an external network, services available with devices on the residential network as WWW services.

It is an object of the present invention to provide, between at least two networks forming respective different network segments, a gateway apparatus that allows a device on one of the networks to use services provided by a device on another one of the networks.

The invention will be described with reference to the accompanying drawings. Throughout the drawings, similar symbols and numerals indicate similar items and functions.

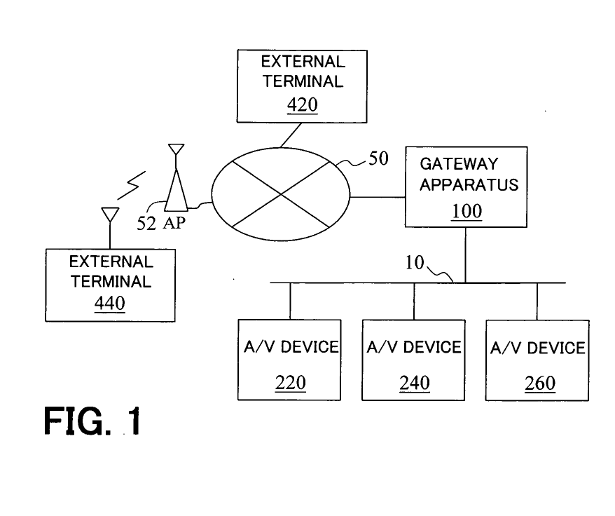

FIG. 1 shows a schematic system, in accordance with an embodiment of the present invention, which system includes a gateway apparatus 100 for UPnP (Universal Plug and Play) audio and/or visual (A/V) content services as a network service providing device, and A/V devices 220, 240 and 260, which are interconnected via an internal network 10 such as a residential local area network (LAN), and external information processing terminals 420 and 440 as network service using devices that are connected to an external network 50 to which the gateway apparatus 100 is connected. The networks 10 and 50 form respective different network segments. The gateway apparatus 100 may be connected, in addition to the internal and external networks 10 and 50, to a further network via a network interface to which further network service providing devices are connected and/or to a further network via a network interface to which further network service using terminals are connected. The external network 50 may include the Internet, ISDN, PSTN and mobile wireless communication network. The devices connected to the internal and external networks 10 and 50 are assigned IP addresses in the same or different address spaces. It is assumed herein that the devices connected to the internal and external networks 10 and 50 are assigned IP addresses in different address spaces, with private IP addresses assigned to the devices connected to the internal network 10 and global IP addresses assigned to those connected to the external network 50.

The gateway apparatus 100 is permanently connected to the external network 50 via a fiber optic, ADSL, ISDN or leased line for example. The A/V devices 220, 240 and 260 may, for example, be personal computers (PCs) having A/V recording/playing/editing functions, A/V and text file servers, A/V recording/playing devices or audio/visual residential monitoring systems. The A/V devices 220, 240 and 260 may be replaced by information processing devices providing information services other than audio/video information. The external terminal 420 can be connected to the gateway apparatus 100 via the external network 50. The external terminal 440 can be connected to the gateway apparatus 100 on the external network 50 via a wireless base station (AP) 52 of a mobile wireless communication network. The external terminals 420 and 440 may, for example, be mobile or non-mobile information processing terminals, such as notebook PCs, PDAs (Personal Digital Assistants) or mobile telephones.

The gateway apparatus 100 relays communications between the external information processing terminals 420 and 440 and the A/V devices 220, 240 and 260 over the internal network 10 and the external network 50 in accordance with the Internet Protocol (IP). The gateway apparatus 100 allows the external information processing terminals 420 and 440 on the external network 50 to use service information and services provided by the A/V devices 220, 240 and 260 on the internal network 10.

A global IP address of the gateway apparatus 100 for the external network 50 is typically dynamically assigned by an Internet service provider (ISP). However, it may be statically assigned. When the gateway apparatus 100 is assigned a new global IP address, it notifies the information processing terminals 420 and 440 of the global IP address at a given timing. The information processing terminals 420 and 440 access the A/V devices 220, 240 and 260 via the gateway apparatus 100 with the IP address, its port number and other information.

Private IP addresses of the gateway apparatus 100 and the A/V devices 220, 240 and 260 for the internal network 10 are typically dynamically assigned by the gateway apparatus 100. However, they may be statically assigned.

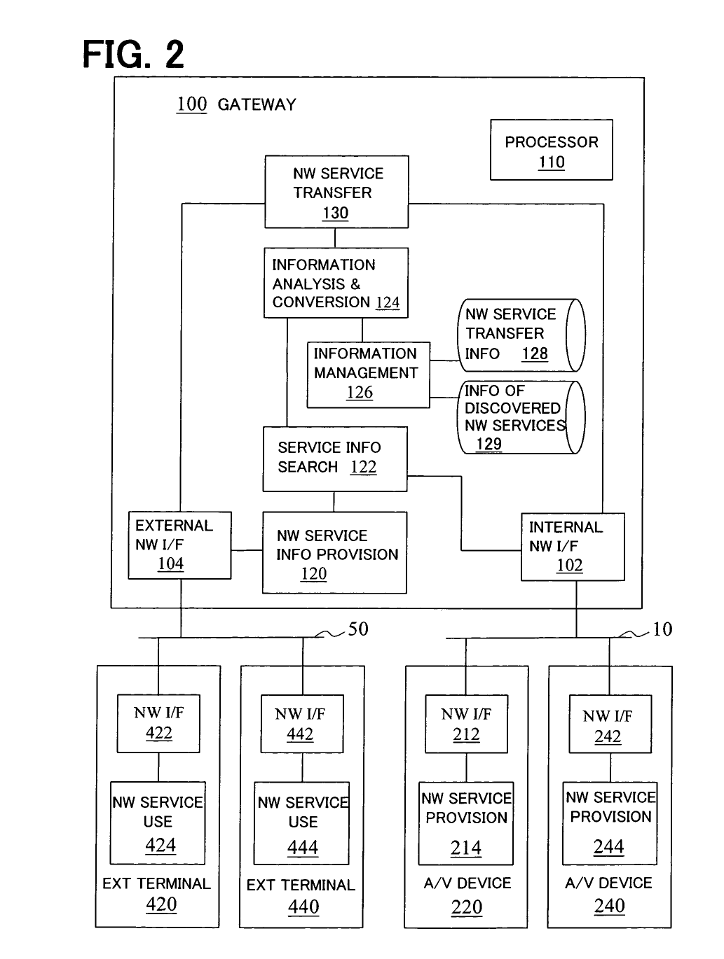

FIG. 2 shows a more detailed configuration of the gateway apparatus 100, the A/V devices 220 and 240, and the external information processing terminals 420 and 440. The gateway apparatus 100 includes an internal network interface (NW I/F) 102 with the internal network 10 as a network segment, an external network interface (NW I/F) 104 with the external network 50 as another network segment, a network service information provision unit 120, a service information search unit 122, an information analysis and conversion unit 124, an information management unit 126, a storage unit 128 for storing network service transfer information, and a network service transfer unit 130, and may further include a storage unit 129 for storing information of discovered network services. The elements 120 to 128 and 130 may be implemented on a processor 110 in accordance with to programs or implemented in hardware form as an integrated circuit. The internal and external network interfaces 102 and 104 include a physical interface such as RJ-45 connectors defined, for example, in the 100 BASE-TX standard, and a virtual network interface as software such as VPN (Virtual Private Network).

The A/V devices 220 and 240 include respective network interfaces 212 and 242 and respective network service provision units 214 and 244, for example, for storing and reading A/V program content.

The information processing terminals 420 and 440 include respective network interfaces 422 and 442 and respective network service using units 424 and 444, for example, for presenting A/V program content. The elements 214, 244, 424 and 444 may be implemented on the processor in accordance with programs or implemented in a hardware form as an integrated circuit.

In the UPnP services such as a content directory service in compliance with the UPnP A/V standard for example, UPnP service information, which is obtained by a service using device from an A/V device over a network, contains detailed service information such as a way of accessing the UPnP A/V content directory service. Content directory service information contains content information, such as a way of accessing content, for example, a URL of the content. Content information contains names of content files so that selection of a name of a content file actually allows the file to be obtained. The UPnP services are configured by a plurality of asynchronous communication procedures, in which a subsequent communication procedure is dependent on a preceding communication procedure in the communications between service using and providing devices.

Conventionally, however, an external device on an external network and an internal device on an internal network cannot directly communicate with each other using their respective global and private IP addresses. In general, the internal device on the internal network can initiate communications with the external device on the external network by rewriting the private IP address and port number in the IP packet header to the global IP address and port number of the gateway apparatus in the support of the NAT (Network Address Translation) or NAPT (Network Address Port Translation) in the gateway apparatus. Even in this case, however, the external device cannot access, using the private URL contained in the response message from the internal device, the device or resource on the internal network associated with the URL.

The gateway apparatus 100 in accordance with an embodiment of the invention tracks, analyzes and converts the content of the packet header, UDP header and payload for each transferred IP packet in the plurality of asynchronous communication procedures for UPnP services between the external information processing terminals 420 and 440 and the A/V devices 220, 240 and 260, to thereby provide advantageous relayed transfer.

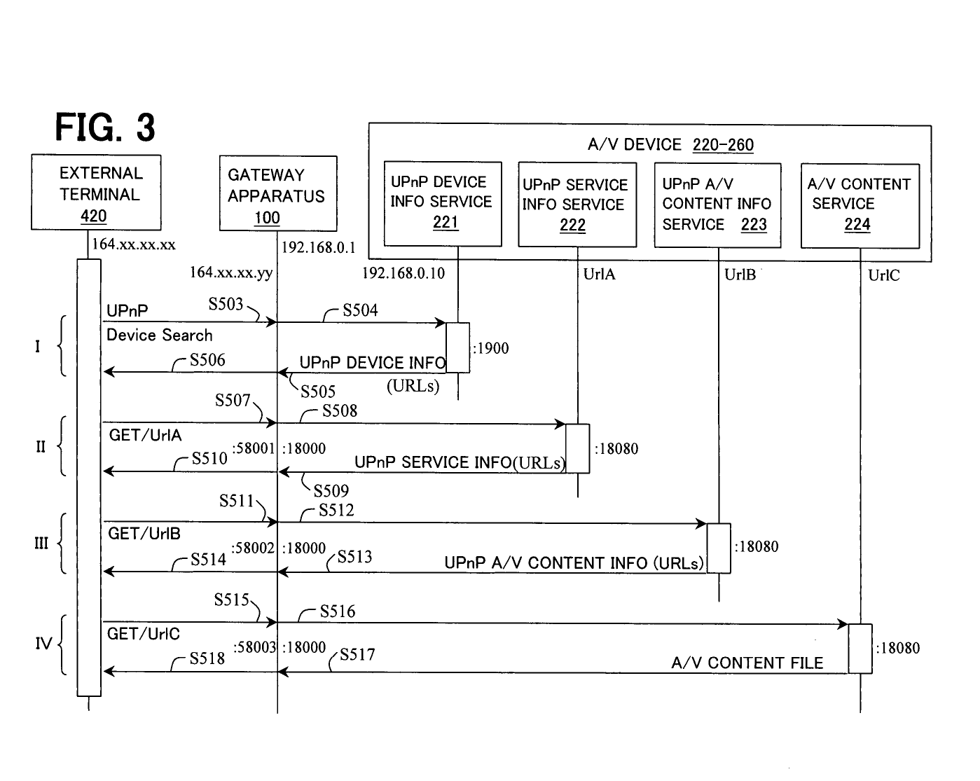

FIG. 3 shows a procedure for processing UPnP A/V content services provided by the A/V devices 220, 240 and 260 via the gateway apparatus 100 to the external information processing terminal 420. The external terminal 420, the gateway apparatus 100 and the A/V device 220 communicate IP packets containing predetermined messages between them asynchronously and sequentially according to a four-stage communication procedure by the UPnP standard. Each of the A/V devices 220, 240 and 260 includes a UPnP device information service unit 221, a UPnP service information service unit 222, a UPnP A/V content information service unit 223 and an A/V content service unit 224, which are hierarchically-layered.

In a first stage I in FIG. 3, in response to a user request for A/V content, the external terminal 420 as an initiator of the request for A/V content at Operation S503 transmits a multicast IP packet representative of a search request over the external network 50. The header of the multicast IP packet contains, for example, 239.255.255.250:1990 as a destination IP address: port number, in compliance with the UPnP standard.

Upon receipt of the IP packet representative of the search request, the gateway apparatus 100 at Operation S504 rewrites the source global IP address in the IP packet header, such as 164.xx.xx.xx, to the private IP address of the gateway apparatus 100, such as 192.168.0.1, as a source address without changing the destination IP address, and transfers the rewritten multicast IP packet to the A/V devices 220, 240 and 260 over the internal network 10.

In response to receipt of the rewritten multicast IP packet, the UPnP device information service units 221 of ones of the individual devices 220, 240 and 260 that are capable of responding thereto transmit back at Operation S505, to the gateway apparatus 100, IP packets, each containing in the payload a response message containing one or more private URLs (as information resource identifiers) representative of UPnP device information available with the ones of the A/V devices 220, 240 and 260, by using, in the IP packet header, destination and source private IP addresses and port numbers of the destination gateway apparatus 100 and of the ones of the A/V devices 220, 240 and 260 and the service units 221 as source entities, respectively. The UPnP device information may be information of, for example, a router, an A/V content server, an A/V display device, a printer or a facsimile device. The URL contains information such as access means (e.g. http or ftp), the private IP addresses of the A/V device 220, 240 and 260, the port numbers and URL identifications of the next UPnP service information service units 222.

In response to receipt of the IP packet containing the response message, the gateway apparatus 100 at Operation S506 rewrites the private IP addresses and port numbers of the destination gateway apparatus 100 and of the source service units 221 in the IP packet header, to the global IP addresses and port numbers of the destination A/V terminal 420 which is the sender of the multicast IP packet and of the source gateway apparatus 100, and further rewrites the plurality of private URLs representative of device information in the payload to a plurality of global URLs. The gateway apparatus 100 may merge the plurality of global URLs, to thereby generate a message containing a list of the plurality of global URLs representative of currently available services for transferring purposes and record the list in the storage unit 128. The gateway apparatus 100 may further record in the storage unit 128 a list of the identifications of the service units 221 of ones of the devices 220, 240 and 260 that did not transmit back response IP packets, as the service units currently not providing services. The gateway apparatus 100 then transmits an IP packet containing the rewritten URLs in the payload back to the external terminal 420. The gateway apparatus 100 may contain, in the payload of the IP packet, a message containing the list of the plurality of global URLs representative of currently available services and of the identifications of the service units currently not providing services. In the global URLs, the private IP addresses of the ones of the devices 220, 240 and 260 and the port numbers of the UPnP device information service units 221 thereof are rewritten to the global IP address of the gateway apparatus 100 and unused port numbers. For example, the private URL “http://192.168.0.10:18080/UrlA” is rewritten to the global URL “http://164.xx.xx.xx.yy:58001/UrlA.”

For the transmitted and received IP packet headers, the gateway apparatus 100 stores, in the storage unit 128 and in a list form, the relationship between the global IP address and port number of the external terminal 420 as the initiator of the request, the global and private port numbers of the gateway apparatus 100 and the private IP addresses and port numbers of the ones of the devices 220, 240 and 260, as network service transfer information. For URLs in the IP packet payload, it also stores, in the storage unit 128 and in a list form, the relationship between the private and global URLs or between private IP addresses and port numbers within private URLs and global IP addresses and port numbers within global URLs, as a part of the network service transfer information.

In a second stage II, the terminal 420 at Operation S507 selects a desired URL from the plurality of rewritten URLs and transmits to the gateway apparatus 100 a global IP packet containing, in the destination field in the IP packet header, the global IP address and port number from the selected URL and also containing, in the payload, a message requesting the acquisition of UPnP service information URLs. Thus the destination field thereof contains the global IP address and port number of the gateway apparatus 100. The URL acquisition request is described, for example, as “GET/UrlA” or “GET/http://164.xx.xx.yy:58001/UrlA.”

In response to receipt of the IP packet, the gateway apparatus 100 at Operation S508 rewrites the destination global IP address and port number in the IP packet header back to the private IP address and port number in accordance with the relationship between the private and global URLs stored in the storage unit 128. If the URL description in the payload contains the destination global IP address and port number, the gateway apparatus 100 similarly rewrites them to the associated private IP address and port number. The gateway apparatus 100 then transmits private IP packets containing the rewritten destinations to the associated UPnP service information service units 222 of the devices 220, 240 and 260.

In response to the message requesting the acquisition of UPnP service information, the UPnP service information service unit 222 at Operation S509 transmits back to the gateway apparatus 100 an IP packet containing, in the payload, a response message that contains UPnP service information of the device 220, 240 or 260, by using the private IP address and port number in the IP packet header. The UPnP service information may be, for example, one or more private URLs representative of ways of accessing, such as programs, files, IP connection services and paths. The URL contains the private IP address of the A/V device 220, 240 or 260 and the port number and URL identification of the next UPnP A/V content information service unit 223.

In response to receipt of the IP packet containing the response message, the gateway apparatus 100 at Operation S510 rewrites the private IP addresses and port numbers of the gateway apparatus 100 as the destination and of the UPnP service information service units 222 as the source in the IP packet header to the global IP addresses and port numbers of the external terminal 420 as the destination that is the sender of the IP packet representative of the URL acquisition request and of the gateway apparatus 100 as the source, and further rewrites the plurality of private URLs representative of the UPnP service information in the payload to a plurality of global URLs as described above. The gateway apparatus 100 then transmits back to the external terminal 420 an IP packet containing in the payload a response message containing a list of the rewritten URLs.

In a third stage III, in response to user selection of a particular URL from global URLs representative of the list of content, i.e., in response to selection of particular UPnP service information, the external terminal 420 at Operation S511 transmits to the gateway apparatus 100 a global IP packet containing, in the destination field in the IP packet header, the global IP address and port number from the selected URL and also containing, in the payload, a message requesting the acquisition of UPnP A/V content information.

In response to receipt of the IP packet, the gateway apparatus 100 at Operation S512 rewrites the destination global IP address and port number in the IP packet header to the private IP address and port number in accordance with the relationship between the private and global URLs stored in the storage unit 128. If the URL description in the payload contains the destination global IP address and port number, the gateway apparatus 100 similarly rewrites them to the private IP address and port number. The gateway apparatus 100 then transmits a private IP packet containing the rewritten destination to the UPnP A/V content information service unit 223 of the A/V devices 220, 240 or 260.

In response to the UPnP A/V content information acquisition request, the UPnP A/V content information service unit 223 at Operation S513 transmits to the gateway apparatus 100 a response message containing, in the payload, UPnP service information of the devices 220, 240 or 260 by using the private IP address and port number in the packet header. The UPnP service information may be, for example, one or more private URLs representative of program file names. The URL contains the private IP address of the device 220, 240 or 260 and the port number and URL identifications of the next A/V content service units 224.

In response to receipt of the IP packet containing the response message, the gateway apparatus 100 at Operation S514 rewrites the private IP addresses and port numbers of the destination and source fields in the header to the global IP addresses and port numbers, and further rewrites the plurality of private URLs representative of the UPnP A/V content information in the payload to a plurality of global URLs as described above. The gateway apparatus 100 then transmits back to the external terminal 420 an IP packet containing in the payload a response message containing a list of the rewritten URLs.

In a fourth stage IV, in response to user selection of a particular URL from global URLs representative of the list of content, i.e., in response to selection of a particular item of A/V content, the external terminal 420 at Operation S515 transmits to the gateway apparatus 100 a global IP packet containing, in the destination field in the IP packet header, the global IP address and port number from the selected URL and also containing, in the payload, a message requesting the acquisition of UPnP A/V content.

In response to receipt of the IP packet, the gateway apparatus 100 at Operation S516 rewrites the destination global IP address and port number in the IP packet header to the private IP address and port number in accordance with the relationship between the private and global URLs stored in the storage unit 128. If the URL description in the payload contains the destination global IP address and port number, the gateway apparatus 100 similarly rewrites them to the private IP address and port number. The gateway apparatus 100 then transmits a private IP packet containing the rewritten destinations to the UPnP A/V content information service units 224 of the A/V devices 220, 240 and 260.

In response to the acquisition request for the particular item of A/V content, the UPnP A/V content information service unit 224 at Operation S517 transmits to the gateway apparatus 100 an IP packet containing in the payload the particular A/V content file associated with the A/V device 220, 240 or 260, by using the private IP address and port number in the IP packet header.

In response to receipt of the IP packet containing the A/V content file, the gateway apparatus 100 at Operation S518 rewrites the private IP addresses and port numbers of the destination and source fields in the IP packet header to the respective global IP addresses and port numbers, as described above, and transmits an IP packet containing the particular A/V content file in the payload to the external terminal 420.

The information analysis and conversion unit 124 in the gateway apparatus 100 rewrites the private IP address: port number contained in the URL in the payload of the response message from the devices 220, 240 and 260 on the internal network 10 to the global IP address: unused port number of the gateway apparatus 100. Then, if it receives access to the same port number of the global IP address from the external network, the information analysis and conversion unit 124 rewrites the destination IP address: port number in the IP packet header and the URL in the payload in accordance with the relationship therebetween stored in the storage unit 128.

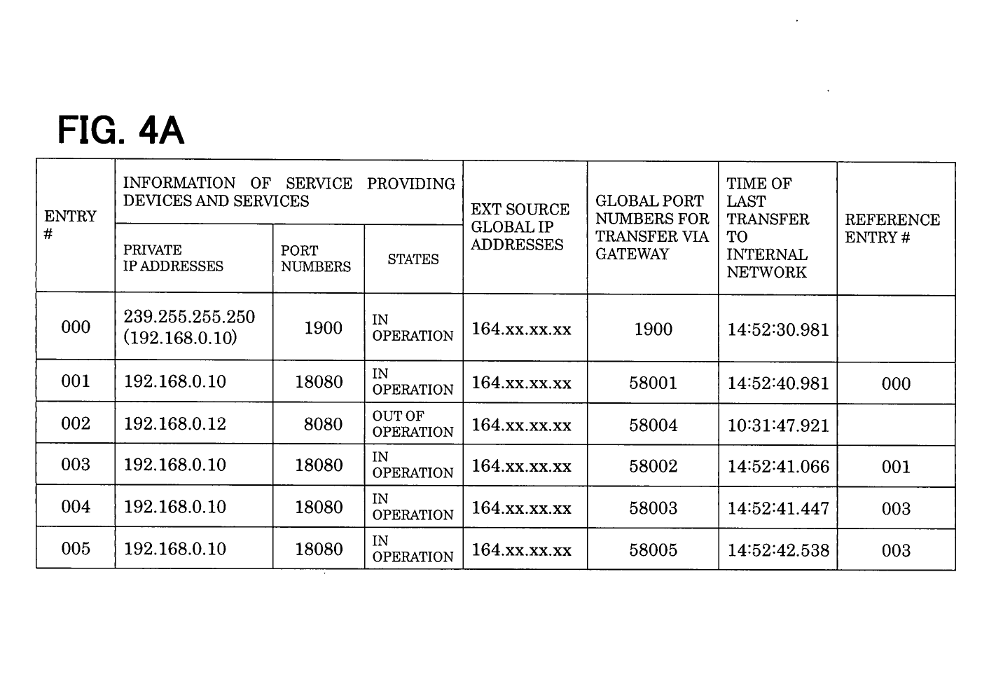

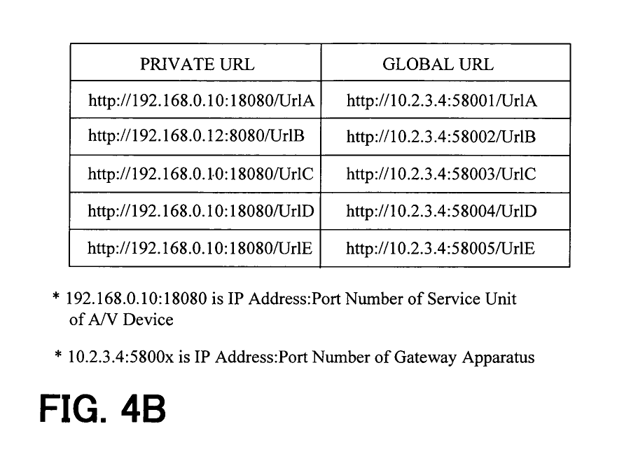

FIG. 4A illustrates network service transfer information stored in the storage unit 128. FIG. 4B shows the relationship stored in the storage unit 128 between private URLs containing private IP addresses and port numbers for the internal network 10 and global URLs containing global IP addresses and port numbers for the external network 50.

It is assumed, for example, that the global IP address of the external terminal 420 is “164.xx.xx.xx”, that the global and private IP addresses of the gateway apparatus 100 are “164.xx.xx.yy” and “192.168.0.1” respectively, and that the private IP address of the internal A/V device 220 is “192.168.0.10”. When the gateway apparatus 100 receives, from the external terminal 420 on the external network 50 having the global IP address: port number “164.xx.xx.xx:9999”, an IP packet representative of a device search request using the destination multicast IP address “239.255.255.250:1900”, the information analysis and conversion unit 124 rewrites the source address of the IP packet to the private IP address “192.168.0.1” of the gateway apparatus 100. The service information search unit 122 transmits the rewritten IP packet to the A/V devices 220, 240 and 260 on the internal network 10. Further, the information management unit 126 writes into the field with the entry number “000” the global IP address “164.xx.xx.xx” of the external terminal 420 as the external source address, the global port number “1900” of the gateway apparatus 100 for transfer purposes, the private IP address: port number “239.255.255.250:1900” of the destination, and the time of last transfer “14:52:30.981” at which the transfer was made last to the internal network 10.

When the service information search unit 122 receives a response IP packet from the UPnP device information service unit 221 of the A/V device 220, 240 or 260, the information analysis and conversion unit 124 rewrites the source “192.168.0.10:1900” and the destination “192.169.0.1:9999” in the response IP packet header to “164.xx.xx.yy:1900” and “164.xx.xx.xx:9999”, respectively. The information management unit 126 writes “In Operation” as the state of the UPnP device information service unit 221 into the field of the entry number “000” in the storage unit 128. The information management unit 126 may rewrite the private IP address of the entry number “000” to “192.168.0.10” of the source address. On the other hand, if no response IP packet is received within a predetermined period of time, the information management unit 126 writes “Out Of Operation” as the state of the UPnP device information service unit 221 into the field of the entry number “000” in the storage unit 128.

If the IP packet received by the network service transfer unit 130 from the internal network 10 contains a private URL in the payload, the information analysis and conversion unit 124 rewrites the private IP address and port number therein to the global IP address and port number of the gateway apparatus 100, to thereby rewrite the private URL to the global URL. The information management unit 126 records, as shown in FIG. 4B, the relationship between private and global URLs in the storage unit 128 as a part of service transfer information.

After that, for example, when the gateway apparatus 100 receives from the external terminal 420 an IP packet representative of URL acquisition request containing, in the IP packet header, the source global IP address: port number “164.xx.xx.xx:9998” and the destination global IP address: port number “164.xx.xx.yy:58001”, the information analysis and conversion unit 124 verifies consistency between the currently received IP packet and the previously transmitted and received IP packets by referencing the external source global IP address, private IP address and port number for the related preceding entry number “000” and by further referencing the relationship between the private and global URLs, and rewrites the source address: port number to the private IP address: port number “192.168.0.1:192.168.0.1:18000” of the gateway apparatus 100 and rewrites the destination to “192.168.0.10:18080” of the UPnP service information service unit 222 of the associated A/V device 220. The network service transfer unit 130 transmits the rewritten IP packet to the UPnP service information service unit 222.

The information management unit 126 writes into the entry number “001” the global IP address “164.xx.xx.xx” of the external terminal 420 as an external source address, the global port number “58001” of the gateway apparatus 100 for transfer purposes, the private IP address: port number “192.168.0.10:18080” of the destination, the last transfer time “14:52:40.9810” at which the transfer was made last to the internal network 10 and the related entry number “000.” When the network service transfer unit 130 receives a response IP packet from the UPnP device information service unit 221, the information analysis and conversion unit 124 rewrites the source address and port number “192.168.0.10:18080” in the response IP packet header to “164.xx.xx.yy:58001” and the destination address and port number “192.168.0.1:18000” to “164.xx.xx.xx:9998”. The information management unit 126 stores “In Operation” as the state of the UPnP device information service unit 221 in the storage unit 128.

After that, the information analysis and conversion unit 124 rewrites the IP addresses and port numbers of related subsequent IP packets until a predetermined period of time elapses from the last transfer time based on the network transfer information. Thus, network service transfer information for the entry numbers “003” to “005” is recorded.

As for the network service transfer information to be stored, if the associated transfer is not made for more than the predetermined period of time after the last transfer time, the entry for the last transfer is invalidated, prohibiting any further transfer from that moment on. In order to make the same transfer again, the external terminal 420 must make a network service search again. This transfer invalidation by elapsed time prevents unnecessary access from external devices to internal network resources.

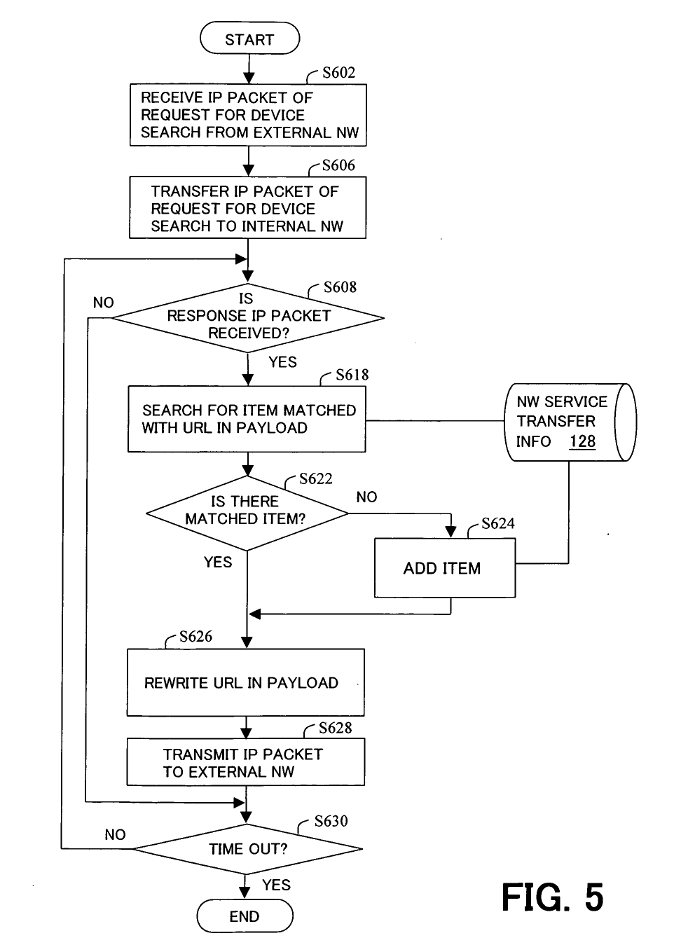

FIG. 5 shows a flowchart for device search, performed by the gateway apparatus 100 in response to a request by the external terminal 420.

First, the external terminal 420 transmits to the gateway apparatus 100 a multicast IP packet representative of a device search request over the external network 50 via the base station 52 in accordance with the user operation.

At step 602 in FIG. 5, the network service information provision unit 120 of the gateway apparatus 100 receives the multicast IP packet representative of the device search request from the external terminal 420 via the external network interface 104.

At step 606, the network service information provision unit 120 provides the IP packet to the service information search unit 122 to request device search. In response to the request, the service information search unit 122 causes the information analysis and conversion unit 124 to rewrite the IP packet header as described above, and transfers the multicast IP packet representative of the device search request to the A/V devices 220, 240 and 260 over the internal network 10 via the internal network interfaces 102. In response to the request, each of the UPnP device information service units 221 of the A/V devices 220, 240 and 260 transmits back to the gateway apparatus 100 a response IP packet containing, in the payload, a URL for obtaining UPnP service information as the associated UPnP device information. The URL contains a private IP address, a port number and an information resource identifier, and is described, for example, as “http://192.168.0.10:18080/UrlA” and “http://192.168.0.12:8080/UrlD”.

At Step 608, the service information search unit 122 determines whether it has received the response IP packet. If the response IP packet has not been received, the procedure advances to Step 630. When the service information search unit 122 has received the response IP packet, it provides at Step 618 the response IP packet to the information analysis and conversion unit 124. The information analysis and conversion unit 124 parses the header and the payload of the response IP packet, extracts the private IP address, the port number and the URL, and provides them to the information management unit 126. The information management unit 126 searches the network service transfer information in the storage unit 128 for an item matched with the URL.

At Step 622, the information management unit 126 determines whether there is any item in the network service transfer information which item is matched with the URL. If it is determined that there is no matched item, the information management unit 126 at Step 624 adds the URL and an associated item to the network service transfer information in the storage unit 128. If it is determined that there is a matched item, the information management unit 126 extracts the item associated with the URL and provides it to the information analysis and conversion unit 124. The service information search unit 122 may further extract the URLs of other service units currently not providing services (221-224) stored in the storage unit 128 via the information management unit 126 and add them to the payload.

At Step 626, the information analysis and conversion unit 124 rewrites the IP packet header and rewrites the private URL in the payload to the global URL as described above, provides the rewritten IP packet to the network service information provision unit 120 via the service information search unit 122. The network service information provision unit 120 at Step 628 transmits to the external terminal 420 which is the sender on the external network 50 an IP packet containing the rewritten URL in the payload via the external network interface 104. In this case, the network service information provision unit 120 may merge a plurality of URLs within one or more IP packets among a plurality of response IP packets, and may transmit an IP packet containing in the payload a list of merged or combined URLs to the external terminal 420.

At Step 630, the information management unit 126 references the network service transfer information in the storage unit 128, to determine whether the predetermined period of time has elapsed from the last transfer time when the IP packet was previously transferred from the external terminal 420 as the sender to the internal network 10. If it is determined that the predetermined period of time has elapsed, the procedure exits from the routine of FIG. 5. When it is determined that the predetermined period of time has not elapsed, the procedure returns to Step 608.

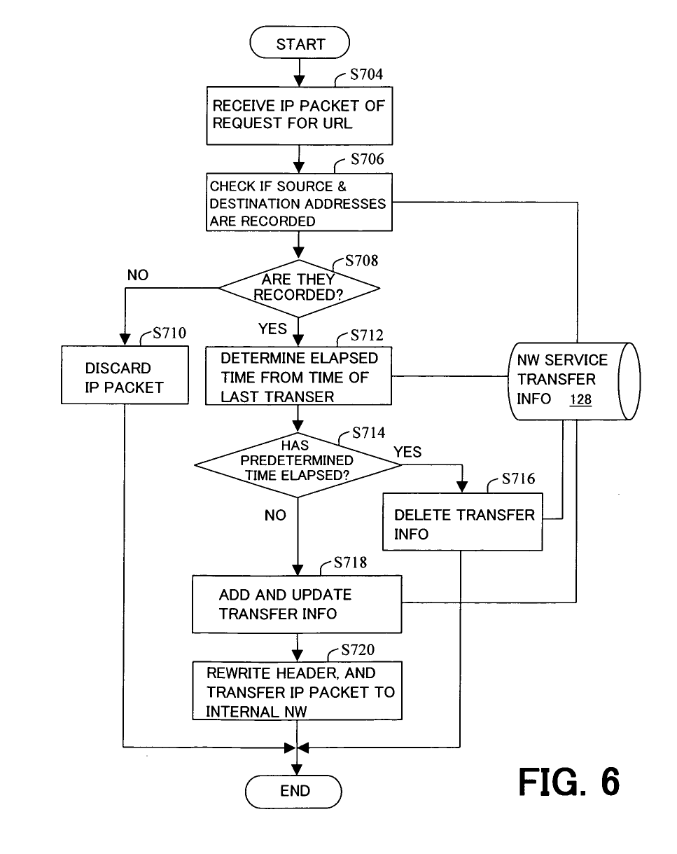

FIG. 6 shows a flowchart for transferring IP packet, performed by the gateway apparatus 100 in response to receipt of an IP packet representative of a request for URL acquisition from the external terminal 420.

The external terminal 420 parses information containing one or more URLs in the payload of the IP packet received from the gateway apparatus 100, and selects, from the one or more URLs, a particular URL associated with the user's request. The external terminal 420 transmits to the gateway apparatus 100 an IP packet containing the IP address and port number from the selected URL within the IP packet header, and a message in the payload that requests acquisition of the URL.

At Step 704 in FIG. 6, the network service transfer unit 130 receives the IP packet representative of the URL acquisition request from the external network 50 via the external network interface 104.

At Step 706, the network service transfer unit 130 provides the received IP packet to the information analysis and conversion unit 124. The information analysis and conversion unit 124 parses the received IP packet, extracts the source global IP address and the destination global IP address in the IP packet header, and provides them to the information management unit 126. The information management unit 126 references the network information service transfer information in the storage unit 128, and checks whether the source and destination have been recorded therein. At Step 706, the information management unit 126 determines whether the source and destination have been recorded. If it is determined that either of the source and destination addresses has not been recorded, the network service transfer unit 130 at Step 710 discards the received IP packet. After that, the procedure exits from the routine of FIG. 6.

If it is determined that both of the source and destination addresses have been recorded, the information management unit 126 at Step 712 references the recorded network service information in the storage unit 128, and determines the elapsed period of time from the last transfer time to the present. At Step 714, the information management unit 126 determines whether the predetermined period of time has elapsed. If it is determined that the predetermined period of time has elapsed, the information management unit 126 at Step 716 deletes the associated information in the network information service transfer information in the storage unit 128. After that, the procedure exits from the routine of FIG. 6. If it is determined that the predetermined period of time has not elapsed, the information management unit 126 adds or updates associated transfer information, such as the last transfer time, in the storage unit 128.

At Step 720, the information analysis and conversion unit 124 rewrites the IP packet header as described above, and, if an URL is contained in the payload, rewrites the URL. The network service transfer unit 130 transfers the rewritten IP packet to the associated service unit of the A/V devices 220, 240 and 260 on the external network 50. After that, the procedure exits from the routine of FIG. 6.

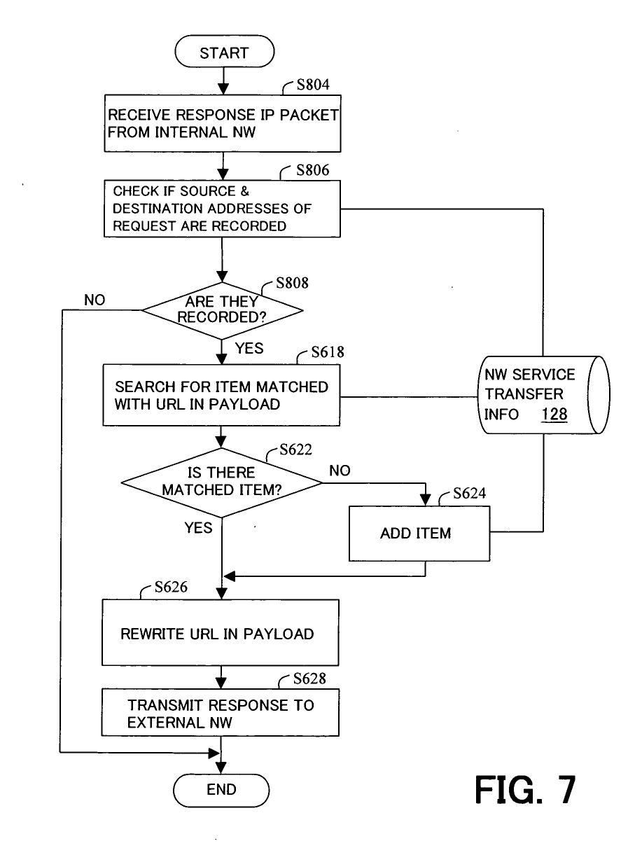

FIG. 7 shows a flowchart for transferring a response IP packet, performed by the gateway apparatus 100 when it receives response IP packets from the A/V devices 220, 240 and 260 in response to requests by the external terminal 420 or 440.

In response to a request by the external terminal 420 or 440, each of the UPnP service information service units 222, UPnP A/V content information service units 223 or A/V content service units 224 in the A/V devices 220, 240 and 260 that are identified with the received destination URLs transmits back to the gateway apparatus 100 a response IP packet containing, in the payload, a plurality of URLs representative of UPnP service information or UPnP A/V content information, or a content file.

At Step 804, the network service transfer unit 130 receives the response packet containing in the payload the next URLs or content files over the internal network 10 via the internal network interface 102.

At Step 806, the network service transfer unit 130 provides the required portion of the response IP packet to the information analysis and conversion unit 124. The information analysis and conversion unit 124 parses the IP packet, extracts the source and destination private IP addresses and port numbers within the IP packet header, and provides them to the information management unit 126. The information management unit 126 references the network information service transfer information in the storage unit 128, and checks whether the global IP addresses and port numbers in the source and destination fields of the IP packet representative of the request by the associated external terminal have been recorded therein. At Step 808, the information management unit 126 determines whether the source and/or destination has been recorded. If it is determined that such information has not been recorded, the procedure exits from the routine of FIG. 7. When it is determined that such information has been recorded, the procedure advances to Step 618. Steps 618 to 628 are the same as those in FIG. 4 and are not described again. The process exits from the routine of FIG. 7 after Step 628.

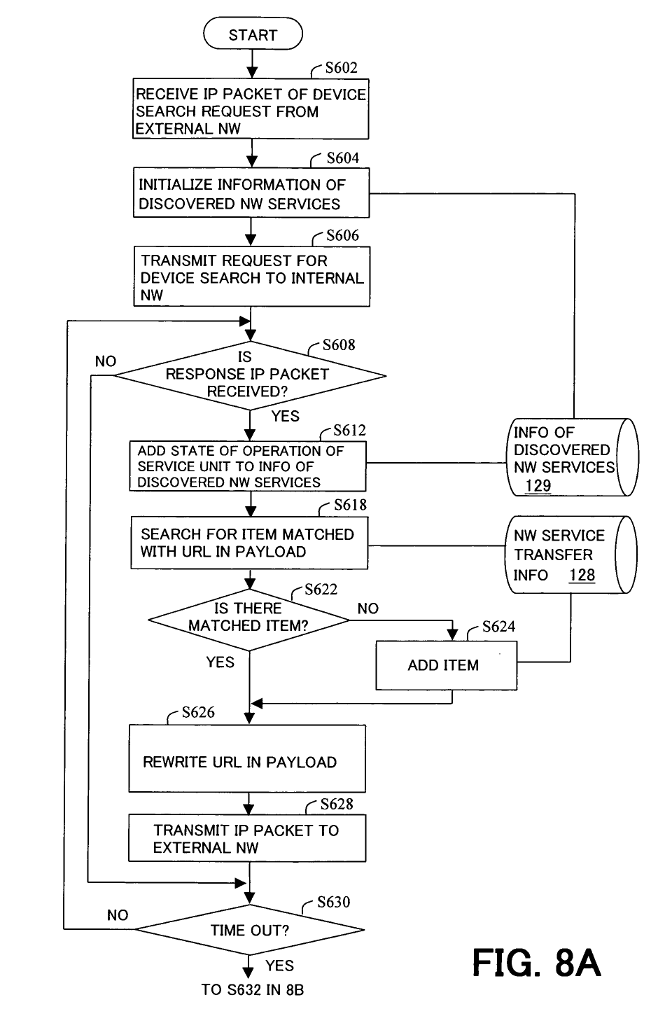

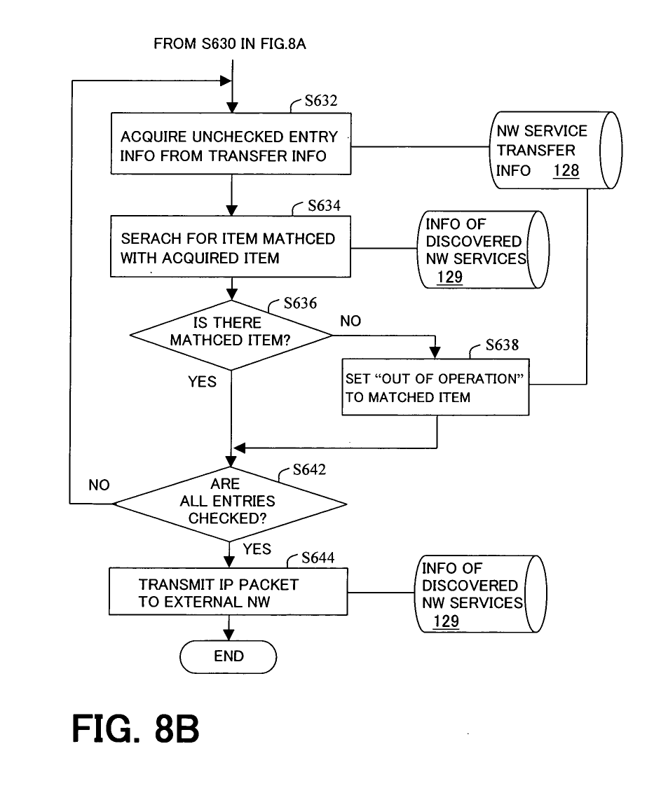

FIGS. 8A and 8B show a modification of FIG. 5, which is another flowchart for device search, performed by the gateway apparatus 100 in response to a request of the external terminal 420. This device search allows providing the operating states of the service providing devices to the service using device. Steps 602, 606 to 608 and 618 to 630 in FIGS. 8A and 8B are the same as those in FIG. 5 and are not described again.

At Step 604 following Step 602, the network service information provision unit 120 causes the information management unit 126 to initialize the information of discovered network services in the storage unit 129 via the service information search unit 122. At Step 612 following Step 608, the information management unit 126 cooperates with the information analysis and conversion unit 124 to reference information related to the UPnP device information service units 221 in the response IP packets received from the UPnP device information service units 221 of the A/V devices 220, 240 and 260, and add items related to the operating states of the UPnP device information service units 221, such as private IP addresses, port numbers and “In Operation” as the operating state to the information of discovered network services in the storage unit 129.

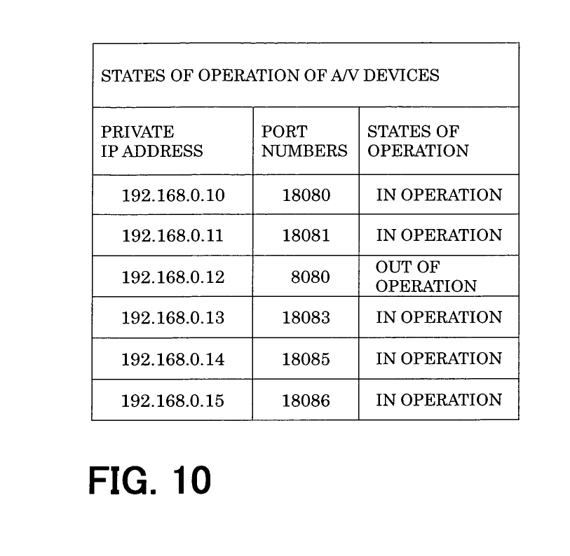

FIG. 10 shows a list of information of discovered network services stored in the storage unit 129. The information of discovered network services contains the private IP addresses, port numbers and current operating states of the A/V device 220 and the like for network services connected to the internal network 10.

At Step 632, the information management unit 126 acquires an unchecked item in the network service transfer information in the storage unit 128. At Step 634, the information management unit 126 searches for an item matched with the acquired item in the information of discovered network services in the storage unit 129.

At Step 636, the service information search unit 122 determines whether there is a response matched with the acquired item. If it is determined that there is a response matched with the acquired item, the procedure advances to Step 642. If it is determined that there is no response matched with the acquired item, the information management unit 126 sets “Out Of Operation” to the associated item in the network service transfer information at Step 638. At Step 642, the service information search unit 122 determines whether all of the entries have been checked. If it is determined that not all of the items have been checked, the procedure returns to Step 632.

If it is determined that all of the items have been checked, the network service information provision unit 120 at Step 644 generates a list of currently available and unavailable network services from the information of discovered network services stored in the storage unit 129, and transmits an IP packet containing the list in the payload to the external terminal 220. Then, the procedure exits from the routine of FIGS. 8A and 8B.

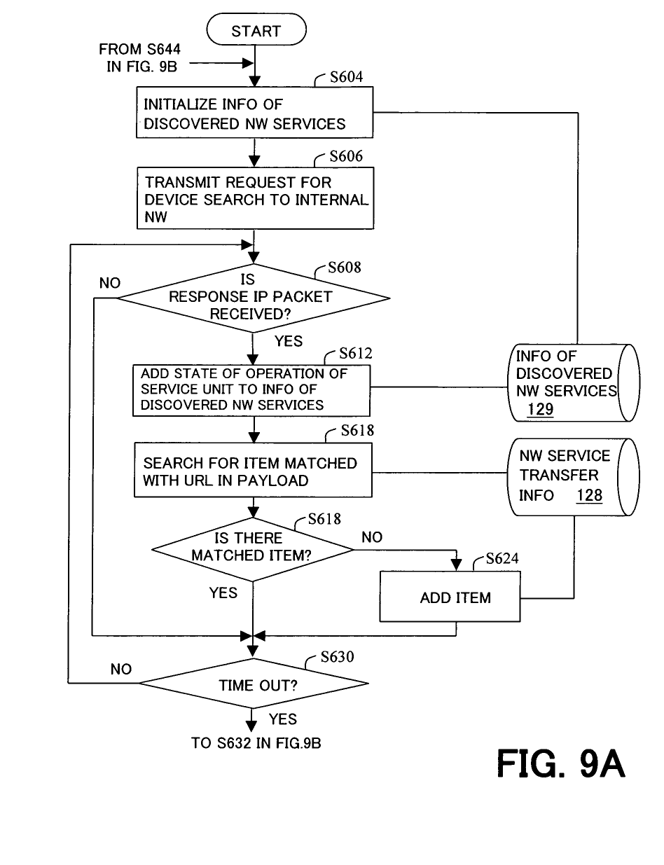

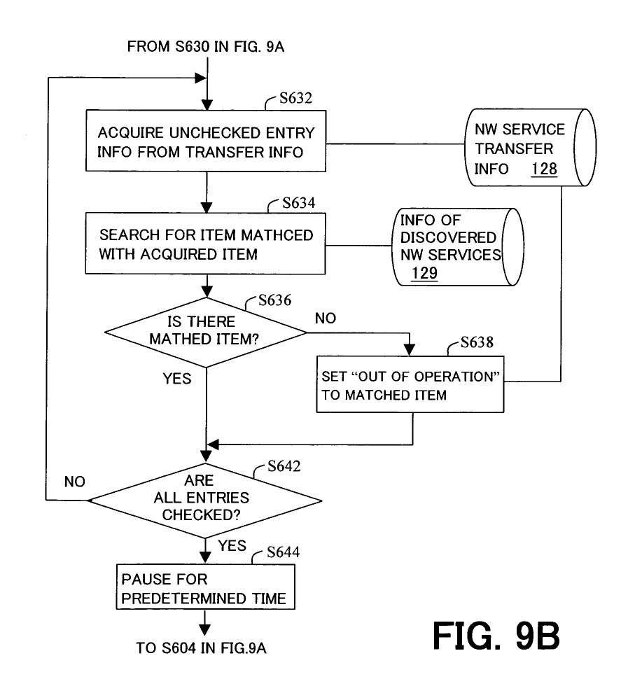

FIGS. 9A and 9B show a modification of FIGS. 8A and 8B, which is a further flowchart for device search, performed by the gateway apparatus 100.

The flowchart of FIGS. 9A and 9B does not include Steps 602, 626 and 628 of FIG. 8A. The flowchart of FIGS. 9A and 9B begins with Step 604. The flowchart of FIG. 5 is executed in parallel with and independently of that of FIGS. 9A and 9B. Steps 604 to 624 and 630 to 642 are the same as those in FIGS. 8A and 8B and are not described again.

At Step 644 following Step 642, the procedure pauses for a predetermined period of time and then returns to Step 632. Thus, the service information search unit 122 detects the operating states of the A/V deices 220 to 240, i.e., whether they are in operation or out of operation regularly, periodically or at fixed time intervals, and stores the states in the storage unit 129. Upon receipt of multicast IP packets representative of device search from the external terminals 420 and 440, the network service information provision unit 120 at Step 628 in FIG. 5 transmits to the external terminals 420 and 440 response IP packets, each containing in the payload the accumulated network service operating states of the A/V devices 220 to 240, i.e., information representative of whether or not the services are available and the list that contains the plurality of merged URLs in FIG. 5.

Alternatively, upon receipt of a multicast IP packet representative of device search from the external terminal 420 or 440, the network service information provision unit 120 may transmit to the external terminal 420 or 440 a response IP packet containing in the payload the stored operating states of the network services (URLs) of the A/V devices 220 to 240, i.e., a list representative of whether or not the services are available. In other words, in FIG. 5, the response IP packet containing the aforementioned list in the payload may be transmitted to the external terminal 420 or 440 at Step 628 following Step 602 without performing Steps 606 to 626 and 630.

Referring back to FIG. 3, when the network service transfer unit 130 receives from the external terminal 420 an IP packet (Steps 507, 511 and 515 in FIG. 3) representative of a request for access to any one of the UPnP device information service units 221 to 224 of the A/V devices 220 to 260 on the internal network 10, and if the service unit corresponds to the service unit (221 to 224) currently out of operation in the network service operating information stored in the storage unit 128 and the device providing the service is currently out of operation, the network service transfer unit 130 may transmit to the external terminal 420 over the external network 50 an IP packet containing a message representing that the service providing device is currently out of operation.

When the network service transfer unit 130 receives from the external terminal 420 an IP packet (Steps 507, 511 and 515 in FIG. 3) representative of a request for access to any one of the UPnP device information service units 221 to 224 of the A/V devices 220 to 260 on the internal network 10, and if the A/V device that was providing the service corresponds to the A/V device currently in operation in the network service operating information stored in the storage unit 128 and the service unit is currently out of operation, the network service transfer unit 130 may transmit to the external terminal 420 over the external network 50 an IP packet containing a message representing that the service is currently out of operation.

When the network service transfer unit 130 receives from the external terminal 420 an IP packet (Steps 507, 511 and 515 in FIG. 3) representative of a request for access to any one of the UPnP device information service units 221 to 224 of the A/V devices 220 to 260 on the internal network 10 over the external network 50, and if the A/V device providing the service corresponds to the A/V device currently out of operation in the network service operating information stored in the storage unit 128 and the A/V device providing the service is currently out of operation, the network service transfer unit 130 may transmit to the A/V device currently out of operation an IP packet containing a message requesting that the A/V device currently out of operation be started such that its service unit becomes available and a message representative of a request for access to the service unit.

The above-described embodiments are only typical examples, and their modifications and variations are apparent to those skilled in the art. It should be noted that those skilled in the art can make various modifications to the above-described embodiments without departing from the principle of the invention and the accompanying claims.

1. A gateway apparatus connected to a plurality of networks which form respective different network segments, said plurality of networks including first and second networks, said gateway apparatus having a first IP address for the first network and a second IP address for the second network, said gateway apparatus comprising:
an information provision unit for receiving, from a second apparatus having a third IP address over the first network, a first IP packet representative of a search request for information resources which packet contains the third IP address as a source address;
a search unit for transmitting over the second network a second IP packet representative of a search request for information resources which packet contains the second IP address as a source address, in response to the first IP packet representative of the search request for information resources, and for receiving over the second network a third IP packet which contains a first information resource identifier representative of an information resource available with a third apparatus on the second network, said first information resource identifier containing a fourth IP address for the third apparatus;
a storage unit for storing the third and fourth IP addresses and the first information resource identifier in association with each other, wherein said information provision unit reads the first information resource identifier from said storage unit, and rewrites the read first information resource identifier to a second information resource identifier containing the first IP address for the first network wherein the fourth IP address within the first information resource identifier is rewritten to the first IP address, and said information provision unit then transmits a fourth IP packet containing the second information resource identifier and the third IP address as a destination address over the first network to the second apparatus; and
a transfer unit, wherein, when a fifth IP packet containing the third IP address as a source address and the first IP address as a destination address is received by said gateway apparatus from the second apparatus over the first network, said transfer unit rewrites the fifth IP packet to a sixth IP packet for the second network containing the second IP address as a source address and the fourth IP address as a destination address wherein the third IP address in the fifth packet is rewritten to the second IP address and the first IP address in the fifth packet is rewritten to the fourth IP address, and said transfer unit then transfers the sixth IP packet over the second network to the third apparatus having a desired information resource.

2. The gateway apparatus according to claim 1, wherein, when said gateway apparatus receives form the third apparatus over the second network a seventh IP packet containing the fourth IP address as a source address and the second IP address as a destination address and containing a third information resource identifier representative of an information resource available with the third apparatus which identifier contains the fourth IP address, said transfer unit rewrites the seventh IP packet to an eighth IP packet containing the first IP address as a source address and the third IP address as a destination address and containing a fourth information resource identifier wherein the fourth IP address in the seventh IP packet is rewritten to the first IP address and the second IP address in the seventh IP packet is rewritten to the third IP address, and said transfer unit then transfers the eighth IP packet over the first network to the second apparatus.

3. The gateway apparatus according to claim 1, wherein the first information resource identifier further contains a first port number of the third apparatus for the second network and the second information resource identifier further contains an unused second port number for the first network in said gateway apparatus, and wherein,
when said gateway apparatus receives from the second apparatus over the first network the fifth IP packet containing the third IP address as a source address and the first IP address and the second port number as the destination, said transfer unit rewrites the fifth IP packet to the sixth IP packet for the second network which packet contains the second IP address as a source address and the fourth IP address and the first port number as the destination wherein the third IP address in the fifth IP packet is rewritten to the second IP address and the first IP address and the second port number in the fifth IP packet are rewritten to the fourth IP address and the first port number respectively, and said transfer unit then transfers the sixth IP packet over the second network to the third apparatus having the available information resource.

4. The gateway apparatus according to claim 1, wherein, while the seventh IP packet which contains the third IP address as a source address and the first IP address as a destination address may be rewritten to the eighth IP packet for the second network which packet contains the second IP address as a source address and the fourth IP address as a destination address and the eighth IP packet can be transferred over the second network until a given time elapses after the sixth IP packet is transferred last to the third apparatus over the second network, the transfer can be prohibited after the given time elapses.

5. The gateway apparatus according to claim 1, wherein said transfer unit is disabled to transfer over the second network an IP packet received over the first network, said IP packet containing an IP address as a source and/or destination IP address other than IP addresses stored in said storage unit.

6. The gateway apparatus according to claim 1, wherein said search unit further regularly transmits over the second network an IP packet representative of a search request for information resources which packet contains the second IP address as a source address, and receives over the second network a response IP packet which contains a particular information resource identifier representative of an available information resource of an available apparatus on the second network, said particular information resource identifier containing an IP address of the available apparatus, and wherein
said storage unit further stores the IP address of the available apparatus and the particular information resource identifier in association with each other.

7. The gateway apparatus according to claim 1, wherein said search unit further regularly transmits over the second network an IP packet representative of a search request for information resources which packet contains the second IP address as a source address, and receives over the second network a response IP packet which contains a particular information resource identifier representative of an available information resource of an available apparatus on the second network, said particular information resource identifier containing an IP address of the available apparatus, and wherein
said storage unit further stores the IP address of the available apparatus and the particular information resource identifier in association with each other in a list form, and wherein,
said information provision unit reads the particular information resource identifier from said storage unit, and rewrites the read particular information resource identifier to another information resource identifier for the first network which identifier contains the first IP address wherein the IP address in the particular information resource identifier is rewritten to the first IP address and the second information resource identifier is merged with the another information resource identifier to generate merged information, and then said information provision unit transmits the fourth IP packet containing the merged information in a list form over the first network to the second apparatus.

8. The gateway apparatus according to claim 1, wherein said search unit stores in said storage unit information representative of the operating states of available resources on the second network and stores information representing that information resources which were available in the past are currently unavailable if the information resources which were available in the past are currently unavailable.

9. The gateway apparatus according to claim 1, wherein, when an IP packet representative of an access request for a desired information resource on the second network is received from the second apparatus over the first network, if the desired information resource corresponds to an information resource currently out of operation in the operating information stored in said storage unit, and another apparatus which was providing the desired information resource is currently out of operation, then said transfer unit transfers over the second network to the second apparatus an IP packet containing a message representing that the other apparatus which was providing the desired information resource is currently out of operation.

10. The gateway apparatus according to claim 1, wherein, when an IP packet representative of an access request for a desired information resource on the second network is received from the second apparatus over the first network, if another apparatus which was providing the desired information resource corresponds to an apparatus currently in operation in the operating information stored in said storage unit, and the desired information resource is currently out of operation, then said transfer unit transfers over the first network to the second apparatus an IP packet containing a message representing that the desired information resource is currently out of operation.

11. The gateway apparatus according to claim 1, wherein, when an IP packet representative of an access request for a desired information resource on the second network is received from the second apparatus over the first network, if an apparatus providing the desired information resource corresponds to an apparatus currently out of operation in the operating information stored in said storage unit, and the apparatus providing the desired information resource is currently out of operation, then said transfer unit transmits over the second network to the apparatus currently out of operation an IP packet containing a message requesting that the apparatus currently out of operation should be started so that the desired information resource becomes available.

12. The gateway apparatus according to claim 1, wherein the IP packet transfer from the first network to the second network is asynchronous with the IP packet transfer from the second network to the first network.

13. The gateway apparatus according to claim 1, wherein communications between the first and second networks comply with the UPnP standard.

14. A gateway apparatus connected to at least first and second networks which form respective different network segments, said gateway apparatus having a first IP address for the first network and a second IP address for the second network, said gateway apparatus comprising:
a search unit for regularly transmitting over the second network an IP packet representative of a search request for information resources which packet contains the second IP address as a source address and for receiving over the second network a response IP packet which contains an information resource identifier representative of an available information resource of an available apparatus on the second network, said information resource identifier containing an IP address of the available apparatus;
a storage unit for storing the IP address of the available apparatus and the information resource identifier in association with each other;
an information provision unit for receiving, from a second apparatus having a third IP address over the first network, a first IP packet representative of a search request for information resources which packet contains the third IP address as a source address, wherein, when the first IP packet is received by said gateway apparatus, said information provision unit stores in a list form the third IP address in association with the IP address of the available apparatus and the information resource identifier, reads from said storage unit a first information resource identifier representative of an available information resource of an available third apparatus on the second network, the first information resource identifier containing a fourth IP address of the third apparatus, and rewrites the read first information resource identifier to a second information resource identifier for the first network containing the first IP address wherein the fourth IP address in the first information resource identifier is rewritten to the first IP address, and said information provision unit then transmits over the first network to the second apparatus a fourth IP packet containing the second information resource identifier in a list form and the third IP address as a destination address, and
a transfer unit wherein, when a fifth IP packet containing the third IP address as a source address and the first IP address as a destination address is received by the gateway apparatus from the second apparatus over the first network, said transfer unit rewrites the fifth IP packet to a sixth IP packet for the second network containing the second IP address as a source address and the fourth IP address as a destination address wherein the third IP address in the fifth IP packet is rewritten to the second IP address and the first IP address in the fifth IP packet is rewritten to the fourth IP address, and said transfer unit then transmits the sixth IP packet over the second network to the third apparatus having a desired information resource.

15. A program product stored on a storage medium for use in a gateway apparatus connected to a plurality of networks which form respective different network segments and for transferring an IP packet, said plurality of networks including first and second networks, said gateway apparatus having a first IP address for the first network and a second IP address for the second network, said program product is operable to effect the steps of:
receiving, from a second apparatus having a third IP address over the first network, a first IP packet representative of a search request for information resources which packet contains the third IP address as a source address;
transmitting over the second network a second IP packet representative of a search request for information resources which packet contains the second IP address as a source address, in response to the first IP packet representative of the search request for information resources, and for receiving over the second network a third IP packet which contains a first information resource identifier representative of an information resource available with a third apparatus on the second network, said first information resource identifier containing a fourth IP address for the third apparatus;
storing in a memory the third and fourth IP addresses and the first information resource identifier in association with each other;
reading the first information resource identifier from said memory, rewriting the read first information resource identifier to a second information resource identifier containing the first IP address for the first network wherein the fourth IP address within the first information resource identifier is rewritten to the first IP address, and then transmitting a fourth IP packet containing the second information resource identifier and the third IP address as a destination address over the first network to the second apparatus; and
rewriting a fifth IP packet which contains the third IP address as a source address and the first IP address as a destination address to a sixth IP packet for the second network containing the second IP address as a source address and the fourth IP address as a destination address when the fifth IP packet is received from the second apparatus over the first IP network, wherein the third IP address in the fifth packet is rewritten to the second IP address and the first IP address in the fifth IP packet is rewritten to the fourth IP address, and then transferring the sixth IP packet over the second network to the third apparatus having a desired information resource.

16. A method for transferring an IP packet in a gateway apparatus connected to a plurality of networks which form respective different network segments, said plurality of networks including first and second networks, said gateway apparatus having a first IP address for the first network and a second IP address for the second network, said method comprising the steps of:
receiving, from a second apparatus having a third IP address over the first network, a first IP packet representative of a search request for information resources which packet contains the third IP address as a source address;
transmitting over the second network a second IP packet representative of a search request for information resources which packet contains the second IP address as a source address, in response to the first IP packet representative of the search request for information resources, and for receiving over the second network a third IP packet which contains a first information resource identifier representative of an information resource available with a third apparatus on the second network, said first information resource identifier containing a fourth IP address for the third apparatus;
storing in a memory the third and fourth IP addresses and the first information resource identifier in association with each other;
reading the first information resource identifier from said memory, rewriting the read first information resource identifier to a second information resource identifier containing the first IP address for the first network wherein the fourth IP address within the first information resource identifier is rewritten to the first IP address, and then transmitting a fourth IP packet containing the second information resource identifier and the third IP address as a destination address over the first network to the second apparatus; and
rewriting a fifth IP packet which contains the third IP address as a source address and the first IP address as a destination address to a sixth IP packet for the second network containing the second IP address as a source address and the fourth IP address as a destination address when the fifth IP packet is received from the second apparatus over the first network, wherein the third IP address in the fifth IP packet is rewritten to the second IP address and the first IP address in the fifth IP packet is rewritten to the fourth IP address, and then transferring the sixth IP packet over the second network to the third apparatus having a desired information resource.
